(19) United States
(12) Patent Application Publication
(10) Pub. No.: US 2025/0207013 A1
(43) Pub. Date: Jun. 26, 2025

(54) TREATMENT COMPOSITIONS INCLUDING ALUMINA PARTICULATE

(71) Applicant: ChampionX LLC, Sugar Land, TX (US)

(72) Inventors: Jeremy Moloney, Katy, TX (US); Duy Nguyen, Richmond, TX (US)

(21) Appl. No.: 18/985,393

(22) Filed: Dec. 18, 2024

Related U.S. Application Data
(60) Provisional application No. 63/613,265, filed on Dec. 21, 2023.

(51) Int. Cl. C09K 8/54; C23F 11/14

(52) U.S. Cl. CPC C09K 8/54; C23F 11/141; C09K 2208/32

(57) ABSTRACT

Treatment compositions including a corrosion inhibitor having an amine group and a particulate including Al₂O₃ are coated on a surface to impart corrosion inhibition thereto. The coated surfaces have improved duration of corrosion inhibition performance with respect to corrodents such as CO₂ and H₂S when compared to the corrosion inhibition performance of the same corrosion inhibitor coating but in the absence of the particulate including Al₂O₃. The coatings are usefully applied to one or more interior and/or exterior surfaces of containments, conduits, and other equipment, such well string completion components, that are contacted by produced fluids containing corrodents.

### BACKGROUND

Nearly all operators in the hydrocarbon extraction and processing industry employ corrosion inhibitors to reduce internal corrosion in metal containments, conduits, and other equipment components contacted by produced fluids containing corrodents. Corrosion inhibitors are applied to various surfaces in the completion string as well as in processing and refinement equipment, where they act to prevent, retard, delay, reverse, and/or otherwise inhibit the corrosion of metal surfaces, such as carbon-steel surfaces. Such use of corrosion inhibitors is recognized to be highly beneficial for extending equipment lifetime.

However, the ability to provide effective corrosion inhibition treatments to the interior surfaces of hydrocarbon recovery and processing equipment, particularly within the enclosed conduits and containments of a completion string of a producing wellbore, is an ongoing challenge. In one commonly employed method, corrosion inhibitors are applied batchwise to a producing wellbore, in amounts empirically based on well production volume. The application is a single “slug” of material, injected into the wellbore in a single batch and distributed through the production string along with the flow of produced fluid emanating from the wellbore. Using this method, efficacy of the treatment trails off quickly over time as fresh produced fluid flows into the wellbore, continuously reducing the concentration of corrosion inhibitor in the system. Additionally, in batch treatment, both the treatment material and equipment to inject the treatment material to the site of the wellbore must be transported to the production site each time, usually by truck. Further, batch treatments are aqueous, and each batch treatment requires a large volume of adjuvant water, such as about 350 liters to about 600 liters (about to 95 gallons to about 160 gallons) per batch, to dilute and flush the batch of corrosion inhibitor into the wellbore. The adjuvant water must be transported to the treatment site along with the treatment material and injection equipment.

In another commonly employed method, the interior surfaces of the completion string of a producing wellbore are coated directly with scale inhibition and/or corrosion inhibition treatments using a “pig”. “Pigging” is a general term for the practice of using devices—pigs—to perform various operations within the interior of hydrocarbon recovery and processing equipment, particularly within the enclosed conduits (pipes) of a completion string of a producing wellbore. Thus, for example, a pig can travel inside one or more conduits of a producing wellbore to clean the interior conduit surface (e.g. by scraping and/or chemical deposition) and/or deposit one or more coating materials directly to the interior surface of the conduit as it travels.

Accordingly, pigging is used broadly in the hydrocarbon extraction and processing industry to apply treatment materials as coatings to one or more interior surfaces of hydrocarbon recovery and processing equipment that contact produced water. Pigging is generally more efficient than batch treatment, at least because pigging does not employ large volumes of adjuvant water.

Coatings applied by pigging are typically a mixture of one or more treatment materials with a solvent such as toluene, xylene, HAN, methyl isobutyl ketone, and the like. However, even after applying a solvent-based treatment composition, the resulting treatment coatings are constantly degraded, and their efficacy decreased, as fresh corrodent-bearing fluid flows through the equipment, continuously challenging the coated surfaces and reducing the amount of treatment material available to benefit the surfaces by preventing corrosion and/or scale buildup.

Accordingly, there is an ongoing need in the oil and gas extraction industry for improved treatment compositions that result in longer periods of treatment efficacy when applied as a coating on the interior surfaces of the completion string of a producing wellbore.

### SUMMARY

Disclosed herein are treatment compositions for coating a surface in need of corrosion inhibition, and treated surfaces formed by coating the treatment compositions thereon. In embodiments, the surface is an interior surface of a pipe or containment. In embodiments, the pipe or containment is part of a completion string of a producing wellbore. The treated surfaces have improved duration of corrosion inhibition performance when compared to performance of the same corrosion inhibitor applied to the same surface in the same amount, but in the absence of the alumina particulate.

The treatment compositions comprise, consist essentially of, or consist of a mixture of a corrosion inhibitor having an amine group, and a particulate including Al₂O₃ (also referred to herein as “alumina particulate”). In embodiments, the corrosion inhibitor having an amine group and the alumina particulate are present in the treatment composition at a weight ratio of 1000:1 to 5:1.

In embodiments, the treatment compositions include 10 wt % to 80 wt % of the corrosion inhibitor having an amine group. In embodiments, the amine group is a primary amine group. In embodiments, the corrosion inhibitor having an amine group comprises, consists essentially of, or consists of an imidazoline, an amidoamine, a quaternary ammonium compound, an aromatic amine, an amine condensate, or a combination of two or more thereof.

In embodiments, the treatment compositions include 0.1 wt % to 2 wt % of the alumina particulate, which is a group of discrete particles comprising, consisting essentially of, or consisting of alumina. In embodiments, the surface of the particles of the alumina particulate consists essentially of alumina, or consists of alumina. In embodiments, the alumina particulate further comprises silica. In embodiments, the average particle size of the alumina particulate is between 1 nm and 1 μm (1000 nm).

In embodiments, the treatment compositions further include a solvent. In some embodiments, the treatment compositions include 20 wt % to 90 wt % of the solvent. In embodiments, the solvent comprises, consists essentially of, or consists of xylene, benzene, toluene, aromatic naphtha, diesel, kerosene, fuel oil, or a combination of two or more thereof.

In embodiments, the treatment compositions are coating compositions, that is, the treatment compositions are used for coating a surface in need of corrosion inhibition, wherein coating is treating. Accordingly, also disclosed herein are methods of treating a surface, the method comprising, consisting essentially of, or consisting of mixing a corrosion inhibitor having an amine group, an alumina particulate, and a solvent to form a treatment composition; and contacting the treatment composition with the surface to form a treated surface. In embodiments, the contacting is carried out in a batch treatment. In embodiments, the batch treatment is dip coating, brush coating, spray coating, or pigging. In embodiments, the pigging is carried out by a smart pig, a spray pig, or a smart spray pig.

Accordingly, also disclosed herein is a treated surface comprising, consisting essentially of, or consisting of a coating disposed on a surface, the coating including, consisting essentially of, or consisting of a mixture of a corrosion inhibitor having an amine group and an alumina particulate. In embodiments, the coating is formed by contacting a treatment composition with the surface, wherein the treatment composition comprises, consists essentially of, or consists of a mixture of a corrosion inhibitor having an amine group, an alumina particulate, and a solvent.

In embodiments, the coating includes about 0.1 wt % to 10 wt % of the alumina particulate. In embodiments, the coating includes about 90 wt % to 99.9 wt % of the corrosion inhibitor having an amine group. In embodiments, the thickness of the coating is 1 μm to 1 mm. In embodiments, the surface includes metal, glass, plastic, or a combination of two or more thereof. In embodiments, the metal surface is a carbon steel surface, a steel alloy surface, a stainless steel surface, a copper alloy surface, a yellow metal surface, or a combination of two or more thereof. In embodiments, the surface is part of a completion string of a producing wellbore. In embodiments, the surface is an interior surface of a pipe or containment.

In embodiments, the methods disclosed herein further include contacting a treated surface with one or more corrodents. In embodiments, the methods disclosed herein further include contacting a treated surface with a crude oil, a produced water, or any combination thereof.

Also disclosed herein are uses of alumina particulates to form corrosion inhibitor treatment compositions. Also disclosed herein are uses of the treatment compositions to form treated surfaces, wherein the treated surfaces have improved duration of corrosion inhibition when compared to the same corrosion inhibitor having an amine group, applied to the same surface in the same amount, but in the absence of the alumina particulate.

### DETAILED DESCRIPTION

Although the present disclosure provides references to preferred embodiments, persons skilled in the art will recognize that changes may be made in form and detail without departing from the spirit and scope of the invention. Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

### Definitions

As used herein, “particulate” refers to a discrete group or mass of particles characterized by a particle size of 1 nm-1000 nm.

As used herein, “particle size” refers to an average particle size, a median particle size, a mean particle size, or a particle size dispersity of an particulate, as specified or determined by context and further as such particle sizes are determined by a method of particle size analysis known by those of ordinary skill in the art of analyzing particles having dimensions of 1000 nm or less. Such methods include light scattering analysis and Coulter counter methods, for example. Unless specified otherwise, “particle size” generally refers to a volume-based average or method of measuring a volume-based average, further assuming spherical particles. When comparing two or more particulates, differences in median particle sizes and/or other particle size parameters are determined based on the respective individually determined median particle sizes and/or other specified parameters.

As used herein, the term “solvent” refers to a compound that is water, a compound that is partially or completely miscible with water, a compound that is a liquid at 25° C./1 atm and has a flashpoint of 100° C. or less, or a mixture of two or more thereof. The term “solvent” may refer to a single compound or a mixture of two or more compounds, as determined by context.

As used herein, the terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

As used herein, the term “optional” or “optionally” means that the subsequently described event or circumstance may but need not occur, and that the description includes instances where the event or circumstance occurs and instances in which it does not.

As used herein, the term “about” modifying, for example, the quantity of an ingredient in a composition, concentration, volume, process temperature, process time, yield, flow rate, pressure, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities. Further, where “about” is employed to describe a range of values, for example “about 1 to 5” the recitation means “1 to 5”, “about 1 to about 5”, “1 to about 5” and “about 1 to 5” unless specifically limited by context.

As used herein, the word “substantially” modifying, for example, the type or quantity of an ingredient in a composition, a property, a measurable quantity, a method, a position, a value, or a range, employed in describing the embodiments of the disclosure, refers to a variation that does not affect the overall recited composition, property, quantity, method, position, value, or range thereof in a manner that negates an intended composition, property, quantity, method, position, value, or range. Examples of intended properties include, solely by way of non-limiting examples thereof, flexibility, partition coefficient, rate, solubility, temperature, and the like; intended values include thickness, yield, weight, concentration, and the like. The effect on methods that are modified by “substantially” include the effects caused by variations in type or amount of materials used in a process, variability in machine settings, the effects of ambient conditions on a process, and the like wherein the manner or degree of the effect does not negate one or more intended properties or results; and like proximate considerations. Where modified by the term “substantially” the claims appended hereto include equivalents to these types and amounts of materials.

### Discussion

The treatment compositions described herein include a mixture of a corrosion inhibitor, or “CI” with a particulate comprising Al₂O₃ (alumina), referred to herein as an “alumina particulate”. The corrosion inhibitor includes an amine group, and is referred to herein as “CI amine”.

The alumina particulate is a discrete group of particles wherein the particles have least one dimension measuring between 1 nm to 1 μm, and have a surface characterized as consisting essentially of, or consisting of alumina (Al₂O₃). In embodiments the alumina particulate consists of or consists essentially of alumina. In other embodiments, the alumina particulate is an alumina-coated silica, such as alumina-coated silica particulates available from CD Bioparticles of Shirley, NY; available under the trade name LEVASIL® from Nouryon of Houston, TX; or by synthesis using the techniques set forth in Jin et al., Colloids and Surfaces A: Physicochemical and Engineering Aspects Volume 441, pp. 170-177 (2014) or Chen et al., Ceramics International Volume 46, Issue 1, pp. 196-203 (2020). In embodiments, the alumina particulate is a mixture of two or more different alumina particulates, that is, alumina particulates having different particle sizes, mixtures of particulates consisting essentially of alumina with alumina-coated particulates; or another mixture of two or more different alumina particulates. In such embodiments, the two or more different alumina particulates are present in the treatment composition in any ratio therein, and the total amount of alumina particulate in the treatment compositions is between 0.1 wt % and 2.0 wt % based on the weight of the treatment compositions.

In embodiments, the alumina particulate is characterized as having a mean particle size or an average particle size in the range of 1 nm-1000 nm, for example 1 nm-900 nm, or 1 nm-800 nm, or 1 nm-700 nm, or 1 nm-600 nm, or 1 nm-500 nm, or 1 nm-400 nm, or 1 nm-300 nm, or 1 nm-200 nm, or 1 nm-100 nm, or 1 nm-50 nm, or 1 nm-10 nm, or 10 nm-1000 nm, or 20 nm-1000 nm, or 100 nm-1000 nm, or 200 nm-1000 nm, or 300 nm-1000 nm, or 400 nm-1000 nm, or 500 nm-1000 nm, or 600 nm-1000 nm, or 700 nm-1000 nm, or 800 nm-1000 nm, or 900 nm-1000 nm, or 10 nm-20 nm, or 20 nm-30 nm, or 30 nm-40 nm, or 40 nm-50 nm, or 50 nm-60 nm, or 60 nm-70 nm, or 70 nm-80 nm, or 80 nm-90 nm, or 90 nm-100 nm, or 100 nm-120 nm, or 120 nm-140 nm, or 140 nm-160 nm, or 160 nm-180 nm, or 180 nm-200 nm, or 100 nm-200 nm, or 200 nm-250 nm, or 250 nm-300 nm, or 300 nm-350 nm, or 350 nm-400 nm, or 400 nm-450 nm, or 450 nm-500 nm, or 500 nm-600 nm, or 600 nm-700 nm, or 700 nm-800 nm, or 800 nm-900 nm.

In embodiments, the treatment compositions comprise between 0.1 wt % and 2.0 wt % of an alumina particulate based on the weight of the treatment composition, for example 0.1 wt % to 1.8 wt %, or 0.1 wt % to 1.6 wt %, or 0.1 wt % to 1.4 wt %, or 0.1 wt % to 1.2 wt %, or 0.1 wt % to 1.0 wt %, or 0.1 wt % to 0.8 wt %, or 0.1 wt % to 0.6 wt %, or 0.1 wt % to 0.4 wt %, or 0.1 wt % to 0.2 wt %, or 0.2 wt % to 2.0 wt %, or 0.4 wt % to 2.0 wt %, or 0.6 wt % to 2.0 wt %, or 0.8 wt % to 2.0 wt %, or 1.0 wt % to 2.0 wt %, or 1.2 wt % to 2.0 wt %, or 1.4 wt % to 2.0 wt %, or 1.6 wt % to 2.0 wt %, or 1.8 wt % to 2.0 wt %, or 0.1 wt % to 0.3 wt %, or 0.2 wt % to 0.4 wt %, or 0.3 wt % to 0.5 wt %, or 0.4 wt % to 0.6 wt %, or 0.5 wt % to 0.7 wt %, or 0.6 wt % to 0.8 wt %, or 0.7 wt % to 0.9 wt %, or 0.8 wt % to 1.0 wt %, or 0.9 wt % to 1.1 wt %, or 1.0 wt % to 1.2 wt %, or 1.1 wt % to 1.3 wt %, or 1.2 wt % to 1.4 wt %, or 1.3 wt % to 1.5 wt %, or 1.4 wt % to 1.6 wt %, or 1.5 wt % to 1.7 wt %, or 1.6 wt % to 1.8 wt %, or 1.7 wt % to 1.9 wt % of an alumina particulate based on the weight of the treatment composition.

In embodiments, the CI amine is an organic amine, or a mixture of two or more organic amines. In some embodiments, the CI amine includes a single amine group; in other embodiments, the CI amine includes two or more amine groups. In embodiments, the CI amine includes 3, 4, 5, 6, 7, 8, 9, or 10 amine groups. In embodiments the CI amine includes one or more primary amine moieties. In embodiments the CI amine includes one or more secondary amine moieties. In embodiments the CI amine includes one or more primary amine moieties, and one or more secondary amine moieties.

In embodiments, the CI amine comprises, consists essentially of, or consists of an imidazoline, an amidoamine, a quaternary ammonium compound, an aromatic amine, an amine condensate, or a combination of two or more thereof.

In embodiments, the CI amine includes, consists essentially of, or consists of an amine condensate. The amine condensate is a reaction product of an organic compound having at least two amine groups, and often at least two primary amine groups, with an organic acid. In embodiments, the amine is ethylene diamine, diethylene triamine, triethylenetetramine, tetraethylenepentamine, N-(2-aminoethyl)-1,2-ethanediamine, or a combination of two or more thereof. In embodiments, the amine condensate is a reaction product of a diamine, triamine, or higher amine, with a fatty acid. In embodiments, the fatty acid is a saturated fatty acid, a monounsaturated fatty acid, a polyunsaturated fatty acid, or a combination of two or more thereof. In embodiments the fatty acid comprises, consists essentially of, or consists of tall oil fatty acid, naphthenic acid, lauric acid, myristic acid, palmitic acid, palmitoleic acid, stearic acid, oleic acid, linoleic acid, arachidonic acid, or a combination of two or more thereof. In embodiments, the amine condensate is a reaction product of diethylene triamine with tall oil fatty acid. In embodiments, the amine condensate is a reaction product of diethylene triamine with oleic acid.

In embodiments, the amine condensate includes, consists essentially of, or consists of an imidazoline. The term “imidazoline” refers to one or more members of the class of heterocycles derived from imidazoles by the reduction of one of the two double bonds. Unless specified otherwise, an imidazoline is a 2-imidazoline, a 3-imidazoline, a 4-imidazoline, or a mixture of two or more thereof. In embodiments, the imidazoline is a 2-imidazoline. In embodiments, the imidazoline has structure 1,

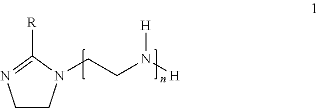

wherein R is a linear or branched alkyl, alkenyl, alkaryl, or aryl group having 12 to 30 carbons and n is an integer between 1 and 5. In embodiments, n is 1 and the imidazoline has structure 1a,

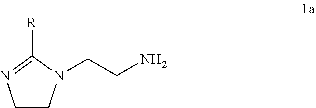

In embodiments, the amine condensate includes, consists essentially of, or consists of an amidoamine, a linear amine-functional amide. In embodiments, the amidoamine has structure 2,

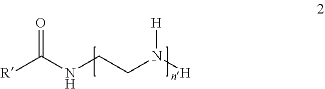

wherein R′ is a linear or branched alkyl, alkenyl, alkaryl, or aryl group having 12 to 30 carbons and n′ is an integer between 1 and 5. In embodiments, R′ is the same or substantially the same as R of structure 1. In embodiments, n′ is the same or substantially the same as n of structure 1. In embodiments, n′ is 1 and the amidoamine has structure 2a.

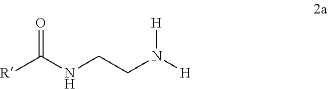

In embodiments, the CI amine comprises, consists essentially of, or consists of a mixture of an imidazoline and an amidoamine. In embodiments, the CI amine comprises, consists essentially of, or consists of a mixture of compounds of structure 1 and structure 2. In embodiments, the CI amine comprises, consists essentially of, or consists of a mixture of compounds of structure 1a and structure 2a.

In embodiments, the CI amine comprises, consists essentially of, or consists of a quaternary ammonium compound. In embodiments, the quaternary ammonium compound comprises, consists essentially of, or consists of a C10-C20 alkyl dimethyl benzyl ammonium chloride, dodecyl didecyl dimethyl ammonium chloride, hexadecyltrimethylammonium chloride, benzalkonium chloride, or a combination of two or more thereof. In embodiments, the quaternary ammonium compound comprises, consists essentially of, or consists of a C12-C18 alkyl dimethyl benzyl ammonium chloride.

In embodiments, the CI amine comprises, consists essentially of, or consists of an aromatic amine. In embodiments, the aromatic amine comprise, consists essentially of, or consists of a pyrimidine, a pyridine, a quinoline, a purine, an acridine, an amino-functionalized pyrimidine, a carboxyl-functionalized pyrimidine, a conjugate base of a carboxyl-functionalized pyrimidine; and combinations of two or more thereof.

In embodiments, the treatment compositions include between 10 wt % and 80 wt % of the CI amine based on the weight of the treatment composition, for example 20 wt % to 80 wt %, or 30 wt % to 80 wt %, or 40 wt % to 80 wt %, or 50 wt % to 80 wt %, or 60 wt % to 80 wt %, or 70 wt % to 80 wt %, or 80 wt % to 90 wt %, or 10 wt % to 70 wt %, or 10 wt % to 60 wt %, or 10 wt % to 50 wt %, or 10 wt % to 40 wt %, or 10 wt % to 30 wt %, or 10 wt % to 15 wt %, or 10 wt % to 20 wt %, or 15 wt % to 20 wt %, or 15 wt % to 25 wt %, or 20 wt % to 25 wt %, or 25 wt % to 30 wt %, or 30 wt % to 35 wt %, or 35 wt % to 40 wt %, or 40 wt % to 45 wt %, or 45 wt % to 50 wt %, or 50 wt % to 55 wt %, or 55 wt % to 60 wt %, or 60 wt % to 65 wt %, or 65 wt % to 70 wt %, or 70 wt % to 75 wt %, or 75 wt % to 80 wt %, or 10 wt % to 30 wt %, or 20 wt % to 40 wt %, or 30 wt % to 50 wt %, or 40 wt % to 60 wt %, or 50 wt % to 70 wt %, or 60 wt % to 80 wt % of the CI amine based on the weight of the treatment composition.

In embodiments, the CI amine is a mixture of two or more different CI amines, that is, CI amines having different chemical composition, different molecular weights, different number of amine groups per molecule, or another mixture of two or more different CI amines. Such mixtures of CI amines includes mixtures of any two or more of the foregoing CI amines listed herein. In such embodiments, the two or more different CI amines are present in a treatment composition in any ratio therein, and the total amount of CI amine in the treatment compositions is between 10 wt % and 80 wt % based on the weight of the treatment compositions.

In embodiments, the treatment compositions include a mixture of a CI amine and an alumina particulate at a weight ratio of 1000:1 to 5:1 [CI amine]:[alumina particulate], for example 1000:1 to 10:1, or 1000:1 to 20:1, or 1000:1 to 30:1, or 1000:1 to 40:1, or 1000:1 to 50:1, or 1000:1 to 60:1, or 1000:1 to 70:1, or 1000:1 to 80:1, or 1000:1 to 90:1, or 1000:1 to 100:1, or 1000:1 to 200:1, or 1000:1 to 300:1, or 1000:1 to 400:1, or 1000:1 to 500:1, or 1000:1 to 600:1, or 1000:1 to 700:1, or 1000:1 to 800:1, or 1000:1 to 900:1, or 900:1 to 5:1, or 800:1 to 5:1, or 700:1 to 5:1, or 600:1 to 5:1, or 500:1 to 5:1, or 400:1 to 5:1, or 300:1 to 5:1, or 200:1 to 5:1, or 100:1 to 5:1, or 90:1 to 5:1, or 80:1 to 5:1, or 70:1 to 5:1, or 60:1 to 5:1, or 50:1 to 5:1, or 40:1 to 5:1, or 30:1 to 5:1, or 20:1 to 5:1, or 10:1 to 5:1, or 10:1 to 20:1, or 20:1 to 30:1, or 30:1 to 40:1, or 40:1 to 50:1, or 50:1 to 60:1, or 60:1 to 70:1, or 70:1 to 80:1, or 80:1 to 90:1, or 90:1 to 100:1, or 100:1 to 200:1, or 200:1 to 300:1, or 300:1 to 400:1, or 400:1 to 500:1, or 500:1 to 600:1, or 600:1 to 700:1, or 700:1 to 800:1, or 800:1 to 900:1, or about 10:1, or about 20:1, or about 30:1, or about 40:1, or about 50:1, or about 60:1, or about 70:1, or about 80:1, or about 90:1, or about 100:1, or about 200:1, or about 300:1, or about 400:1, or about 500:1, or about 600:1, or about 700:1, or about 800:1, or about 900:1, or about 1000:1 [CI amine]:[alumina particulate] by weight.

In embodiments, the treatment compositions are easily formed by admixing the selected components; no particular order of mixing or special mixing apparatus is required. In embodiments, . . . .

Solvents. In embodiments, the CI amine and the alumina particulate are further combined or mixed with a solvent to form a treatment composition that is useful for coating a surface to obtain corrosion inhibition thereof. Accordingly, in embodiments, the treatment compositions further include a solvent. In embodiments, the solvent comprises, consists essentially of, or consists of xylene, benzene, toluene, aromatic naphtha solvents including HAN, diesel, kerosene, fuel oil, or a combination of two or more thereof. In embodiments, the solvent comprises, consists essentially of, or consists of a mixture of xylene, benzene, toluene, aromatic naphtha solvents including HAN, diesel, kerosene, fuel oil, or a combination of two or more thereof, with water or a water-miscible or partially water-miscible solvent such as C1-C6 alkanols, C1-C4 aldehydes, C3-C5 ketones, and C2-C6 diols, triols, and polyols, including glycerol and sugar alcohols.

In embodiments, the treatment compositions include between 20 wt % and 90 wt % solvent based on the weight of the treatment composition, for example 30 wt % to 90 wt %, or 40 wt % to 90 wt %, or 50 wt % to 90 wt %, or 60 wt % to 90 wt %, or 70 wt % to 90 wt %, or 80 wt % to 90 wt %, or 20 wt % to 80 wt %, or 20 wt % to 70 wt %, or 20 wt % to 60 wt %, or 20 wt % to 50 wt %, or 20 wt % to 40 wt %, or 20 wt % to 30 wt %, or 20 wt % to 25 wt %, or 25 wt % to 30 wt %, or 30 wt % to 35 wt %, or 35 wt % to 40 wt %, or 40 wt % to 45 wt %, or 45 wt % to 50 wt %, or 50 wt % to 55 wt %, or 55 wt % to 60 wt %, or 60 wt % to 65 wt %, or 65 wt % to 70 wt %, or 70 wt % to 75 wt %, or 75 wt % to 80 wt %, or 10 wt % to 20 wt %, or 20 wt % to 30 wt %, or 30 wt % to 40 wt %, or 40 wt % to 50 wt %, or 50 wt % to 60 wt %, or 60 wt % to 70 wt %, or 70 wt % to 80 wt %, or 80 wt % to 90 wt %, or 20 wt % to 40 wt %, or 40 wt % to 60 wt %, or 60 wt % to 80 wt %, or 30 wt % to 50 wt %, or 50 wt % to 70 wt %, or 70 wt % to 90 wt % of the solvent based on the weight of the treatment composition. In embodiments, the solvent is a substantially a single compound; in other embodiments the solvent is a mixture of two or more compounds. In embodiments, the solvent comprises, consists essentially of, or consists of water. In embodiments, the solvent comprises, consists essentially of, or consists of a compound that is partially or completely miscible with water. In embodiments, the solvent comprises, consists essentially of, or consists of a compound that is immiscible with water. In embodiments, the solvent comprises, consists essentially of, or consists of a compound that is a liquid at 25° C./1 atm and has a flashpoint of 100° C. or less. In embodiments, the solvent includes aromatic functionality. In embodiments, the solvent comprises, consists essentially of, or consists of benzene, toluene, ethylbenzene, xylene, aromatic naphtha, or a combination of two or more thereof.

In embodiments, the treatment compositions described herein include one or more adjuvants. Adjuvants are materials or compounds that improve the ease of applying a treatment composition to a surface to form a coating thereon; and/or increase the durability of a coating of the treatment composition formed on a surface; and/or increase the corrosion inhibition of a surface; and/or add a new type of performance to the treatment composition or to a coating formed by applying a treatment composition to a surface, such as antimicrobial, antifungal, antifouling, and/or paraffin inhibition performance.

In embodiments, the one or more adjuvants is selected from biocides, hydrogen sulfide scavengers, anti-emulsifiers, anti-foaming agents, emulsifiers, foamers, paraffin inhibitors, asphaltene inhibitors, hydrate inhibitors, or a combination of two or more thereof.

In embodiments, one or more treatment compositions disclosed herein further include one or more adjuvants, wherein an adjuvant or a combination of two or more adjuvants are present in the treatment composition in an amount between 0.01 wt % and 10 wt % based on the weight of treatment composition, such as 0.01 wt % to 0.1 wt %, or 0.01 wt % to 1 wt %, or 0.1 wt % to 1 wt %, or 1 wt % to 5 wt %, or 5 wt % to 10 wt %, or 1 wt % to 2 wt %, or 2 wt % to 3 wt %, or 3 wt % to 4 wt %, or 4 wt % to 5 wt %, or 5 wt % to 6 wt %, or 6 wt % to 7 wt %, or 7 wt % to 8 wt %, or 8 wt % to 9 wt %, or 9 wt % to 10 wt % based on the weight of treatment composition. In embodiments, one or more treatment compositions disclosed herein further include two or more adjuvants, wherein the combination of two or more adjuvants is present in the treatment composition in an amount between 10 wt % and 20 wt %, such as 10 wt % to 12 wt %, or 12 wt % to 14 wt %, or 14 wt % to 16 wt %, or 16 wt % to 18 wt %, or 18 wt % to 20 wt %, or 10 wt % to 15 wt %, or 15 wt % to 20 wt %, or about 10 wt %, or about 11 wt %, or about 13 wt %, or about 14 wt %, or about 15 wt %, or about 16 wt %, or about 17 wt %, or about 18 wt %, or about 19 wt %, or about 20 wt % based on the weight of treatment composition.

In embodiments, a suitable adjuvant included in one or more treatment compositions comprises, consists essentially of, or consists of an antifouling agent. Antifouling agents are materials or compounds that reduce or eliminate the deposition of solids on a surface. Antifouling agents include, but are not limited to, copolymers of unsaturated fatty acids, primary diamines, and acrylic acid; copolymers of methacrylamidopropyl trimethylammonium chloride with acrylic acid and/or acrylamide; copolymers of ethylene glycol and propylene glycol; and blends of two or more thereof.

In embodiments, a suitable adjuvant included in one or more treatment compositions comprises, consists essentially of, or consists of an antimicrobial agent. Antimicrobial agents include, but are not limited to, compounds with a microbiostatic, disinfectant, or sterilization effect on a liquid material when added thereto. Nonlimiting examples of antimicrobials include bactericides, fungicides, nematicides, and the like. Bactericides include active chlorine disinfectants, e.g. including hypochlorites, chlorine dioxide, and the like; phenols such as triclosan, phenol itself, thymol, and the like; cationic surfactants such as quaternary ammonium surfactants, chlorhexidine, and the like; ozone, permanganates, colloidal silver, silver nitrate, copper based compounds, iodine preparations, peroxides, and strong acids and strong alkalis. Fungicides include, but are not limited to, strobilurins such as azoxystrobin, trifloxystrobin and pyraclostrobin; triazoles and anilino-pyrimidines such as tebuconazole, cyproconazole, triadimefon, pyrimethanil; and additionally compounds such as triadimefon, benomyl, captan, chlorothalonil, copper sulfate, cyproconazole, dodine, flusilazole, flutolanil, fosetyl-al, gallex, mancozeb, metalaxyl, prochloraz, propiconazole, tebuconazole, thiophanate methyl, triadimenol, tridimefon, triphenyltin hydroxide, ziram, and the like.

### Treated Surfaces and Methods of Treating

In accordance with the treatment compositions disclosed herein, methods of treating a surface comprise, consist essentially of, or consist of combining or mixing an alumina particulate, an amine CI, and a solvent to form a treatment composition; and contacting the treatment composition with a surface to form a treated surface. In embodiments, the methods further include combining one or more adjuvants with the treatment composition. In embodiments, the surface is a metal surface, a glass surface, a plastic surface, or a combination of two or more thereof. In embodiments, the metal surface is a carbon steel surface, a steel alloy surface, a stainless steel surface, a copper alloy surface, a yellow metal surface, or a combination of two or more thereof. In embodiments, the surface is an interior surface of a pipe, tube, separator, or containment, or a portion of such interior surface. In embodiments, the surface is an exterior surface of a pipe, tube, separator, or containment, or a portion of such exterior surface, further wherein in some embodiments, the pipe or containment is part of a well completion string of a producing well. In embodiments, the surface is located on a wellbore production string, on a water treatment facility, on a boiler, on a geothermal heat pump system, on a nuclear processing facility, on a water cooling tower, or on a combination of two or more thereof.

In embodiments, the treated surfaces comprise, consist essentially of, or consist of a surface having a coating disposed thereon, wherein the coating comprises, consists essentially of, or consists of a mixture of a CI amine and an alumina particulate present at a weight ratio of 1000:1 to 5:1 [CI amine]:[alumina particulate], for example 1000:1 to 10:1, or 1000:1 to 20:1, or 1000:1 to 30:1, or 1000:1 to 40:1, or 1000:1 to 50:1, or 1000:1 to 60:1, or 1000:1 to 70:1, or 1000:1 to 80:1, or 1000:1 to 90:1, or 1000:1 to 100:1, or 1000:1 to 200:1, or 1000:1 to 300:1, or 1000:1 to 400:1, or 1000:1 to 500:1, or 1000:1 to 600:1, or 1000:1 to 700:1, or 1000:1 to 800:1, or 1000:1 to 900:1, or 900:1 to 5:1, or 800:1 to 5:1, or 700:1 to 5:1, or 600:1 to 5:1, or 500:1 to 5:1, or 400:1 to 5:1, or 300:1 to 5:1, or 200:1 to 5:1, or 100:1 to 5:1, or 90:1 to 5:1, or 80:1 to 5:1, or 70:1 to 5:1, or 60:1 to 5:1, or 50:1 to 5:1, or 40:1 to 5:1, or 30:1 to 5:1, or 20:1 to 5:1, or 10:1 to 5:1, or 10:1 to 20:1, or 20:1 to 30:1, or 30:1 to 40:1, or 40:1 to 50:1, or 50:1 to 60:1, or 60:1 to 70:1, or 70:1 to 80:1, or 80:1 to 90:1, or 90:1 to 100:1, or 100:1 to 200:1, or 200:1 to 300:1, or 300:1 to 400:1, or 400:1 to 500:1, or 500:1 to 600:1, or 600:1 to 700:1, or 700:1 to 800:1, or 800:1 to 900:1, or about 10:1, or about 20:1, or about 30:1, or about 40:1, or about 50:1, or about 60:1, or about 70:1, or about 80:1, or about 90:1, or about 100:1, or about 200:1, or about 300:1, or about 400:1, or about 500:1, or about 600:1, or about 700:1, or about 800:1, or about 900:1, or about 1000:1 [CI amine]: [alumina particulate] by weight.

In some embodiments, contacting a surface with the treatment composition is coating the surface with the treatment composition. In embodiments, contacting the surface is accomplished in a continuous process; in other embodiments, contacting the surface is accomplished in a batchwise process. In embodiments, the surface is coated with the treatment composition at a coating thickness of 1 μm to 1 mm, for example 1 μm to 900 μm, or 1 μm to 800 μm, or 1 μm to 700 μm, or 1 μm to 600 μm, or 1 μm to 500 μm, or 1 μm to 400 μm, or 1 μm to 300 μm, or 1 μm to 200 μm, or 1 μm to 100 μm, or 1 μm to 50 μm, or 1 μm to 25 μm, or 1 μm to 10 μm, or 10 μm to 1 mm, or 25 μm to 1 mm, or 50 μm to 1 mm, or 100 μm to 1 mm, or 200 μm to 1 mm, or 300 μm to 1 mm, or 400 μm to 1 mm, or 500 μm to 1 mm, or 600 μm to 1 mm, or 700 μm to 1 mm, or 800 μm to 1 mm, or 900 μm to 1 mm, or 10 μm to 100 μm, or 100 μm to 200 μm, or 200 μm to 300 μm, or 300 μm to 400 μm, or 400 μm to 500 μm, or 500 μm to 600 μm, or 600 μm to 700 μm, or 700 μm to 800 μm, or 800 μm to 900 μm, or 100 μm to 300 μm, or 200 μm to 400 μm, or 300 μm to 500 μm, or 400 μm to 600 μm, or 500 μm to 700 μm, or 600 μm to 800 μm, or 700 μm to 900 μm, or 800 μm to 1 mm, to form the treated surface.

In embodiments, a treatment composition is applied to a surface using a batchwise treatment method. Suitable batchwise treatment methods include dip coating, brush coating, or spray coating. In embodiments, the batchwise treatment method is pigging. In embodiments, pigging is carried out using a smart pig, a spray pig, a smart spray pig, or a combination of two or more thereof.

A treated surface formed in accordance with the methods disclosed herein is a surface having a coating disposed on at least a portion thereof, wherein the coating includes an amine CI and an alumina particulate. Accordingly, disclosed herein is a coating disposed on a surface, the coating comprising, consisting essentially of, or consisting of a mixture of an amine CI and an alumina particulate. The coating comprises, consists essentially of, or consists of an amine CI and an alumina particulate. The treated surfaces have an unexpectedly long duration of corrosion inhibiting performance. Unexpectedly, the treated surfaces formed in accordance with the methods disclosed herein have improved the duration of corrosion inhibition performance when compared to the performance of the same corrosion inhibitor applied to the same surface in the same amount but in the absence of the alumina particulate.

Without being limited by theory, we believe that after contacting a surface—such as an interior surface of a pipe or containment—with a treatment composition as described herein, the alumina particulate assists in aggregation, flocculation, and/or precipitation of the amine CI onto the coated surface. Alternatively, also without being limited by theory, the alumina particulate may itself adsorb to the surface, in embodiments immobilizing or trapping the amine CI therewith. Accordingly, in embodiments, we have observed that the treated surfaces have improved duration of corrosion inhibition performance when compared to performance of the same amine CI applied to the same surface in the same amount, but in the absence of the alumina particulate.

In embodiments, surfaces usefully treated by contacting with the treatment compositions include interior and/or exterior surfaces or portions of interior and/or exterior surfaces of pipes, containments, tubes, separators, and combinations of these. In embodiments one or more surfaces usefully treated by contacting with the treatment compositions are located on a wellbore production string, on a water treatment facility, on a boiler, on a geothermal heat pump system, on a nuclear processing facility, on a water cooling tower, or a combination of two or more thereof. In embodiments the pipe or containment is further subjected to a fluid flow, such as a flow of crude oil and/or produced water that contacts the treated interior surface. Unexpectedly, we have observed that the treated interior surfaces obtain improved performance durability during such fluid flow, when compared to the same CI amine applied to the same surface(s) in the same amount, but in the absence of the alumina particulate. Stated differently, when a treated surface including an CI amine and an alumina particulate coated thereon, is subsequently contacted with a fluid including a corrodent, corrosion of the treated surface is inhibited for a longer period of time than the same surface contacted with the same corrosion inhibitor but in the absence of the alumina particulate, then contacted with the same corrodent-bearing fluid.

Accordingly, in embodiments the methods described herein comprise, consist essentially of, or consist of mixing an amine CI and an alumina particulate with a solvent to form a treatment composition; contacting a surface with the treatment composition to form a treated surface; and contacting the treated surface with an aqueous fluid flow having one or more corrodents present therein, that is, dissolved or dispersed therein. In embodiments, the fluid flow is obtained from a wellbore production string, a water treatment facility, a boiler, a geothermal heat pump system, a nuclear processing facility, a water cooling tower, or a combination of two or more thereof. In embodiments, the fluid flow is a flow of crude oil and/or produced water. In embodiments, the corrodent present in the fluid flow comprises, consists essentially of, or consists of H₂S. In embodiments, the corrodent comprises dissolved CO₂, an organic acid, a mineral acid, or a combination of two or more thereof. In embodiments, a surface treated in accordance with the methods herein obtains improved corrosion inhibition durability when subjected to a corrodent-laden fluid flow, when compared to the same amine CI applied to the same surface in the same amount but in the absence of the alumina particulate.

Accordingly, in embodiments, we have observed that the treated surfaces have improved duration of corrosion inhibition performance when compared to performance of the same amine CI applied to the same surface in the same amount, but in the absence of the alumina particulate. In embodiments, the duration of corrosion inhibition obtained by the treated surfaces is at least 10% longer, in embodiments 100% longer, even 200% longer, and in some embodiments as much as 500% longer than the same level of corrosion inhibition obtained by the same amine CI, applied to the same surface in the same amount, but in the absence of the alumina particulate. In embodiments, the percentage of corrosion inhibition obtained by the treated surfaces is more than twice the inhibition (>100% greater inhibition) obtained by the same amine CI, applied to the same surface in the same amount, but in the absence of the alumina particulate.

### EXAMPLE

A condensate of tall oil fatty acid with diethylene triamine (TOFA-DETA) was combined with xylene to form a 50 wt % solution of TOFA-DETA in xylene (“Control”). A colloidal dispersion of alumina in water (less than 30% solids) having a particle size of less than 100 nm was combined with xylene and TOFA-DETA to form mixture having 50 wt % TOFA-DETA and 0.5 wt % Al₂O₃ in xylene (“Example”).

Corrosion tests comparing the Control to the Example were performed using pre-weighed C1018 mild steel coupons (¼″×7⅜″) with sandblast finish. To make a test sample, a coupon is dipped for about 5 seconds in either the Control mixture or the Example mixture, then removed; and excess liquid is allowed to drip from the coupon for about 10 seconds to result in a treated coupon. This treatment approximates batch treatment of coating materials applied in the field to the interior of pipes by pigging.

The treated coupon is immediately placed in a vessel containing a CO₂-saturated solution of 3% NaCl and the vessel is closed. The closed vessel is mounted on a wheel in a temperature-controlled cabinet set to a temperature of 60° C.; and the wheel is rotated at 26 rpm continuously for a first 24 hour period. After the first 24 hour period the rotating is stopped, and the CO₂-saturated 3% NaCl solution is replaced with fresh CO₂-saturated 3% NaCl, and the wheel is rotated for a second 24 hours period for a total of 48 hours of rotating. After the second 24 hour period the rotating is stopped, and the CO₂-saturated 3% NaCl solution is replaced with fresh CO₂-saturated 3% NaCl, and the wheel is rotated for a third 24 hour period for a total of 72 hours of rotating. After the third 24 hour period the rotating is stopped, and the CO₂-saturated 3% NaCl solution is replaced with fresh CO₂-saturated 3% NaCl, and the wheel is rotated for a fourth 24 hour period for a total of 96 hours of rotating. At the end of the 96 hour period, the coupons are removed from the vessel, cleaned and re-weighed and the corrosion rate in milli-inches per year (mpy) is determined by weight loss of the coupon.

The percentage of corrosion inhibition is determined by comparison to a blank, i.e. the foregoing test carried out on an untreated C1018 mild steel coupon.

The results of the corrosion inhibition test carried out on an untreated C1018 mild steel coupon (Blank) in addition to the Control and the Example is shown in Table 1. Two coupons were separately tested in each case to ensure consistency and reproducibility of the test results.

TABLE 1
Corrosion inhibition test results obtained with treated Example coupons,
Control coupons, and untreated C1018 mild steel coupons.

| Treatment | Corrosion | % |
|---|---|---|
| | Rate, mpy | Protection |
| None (Blank) | 17.98 | N/A |
| ″ | 17.10 | N/A |
| Control | 12.34 | 30 |
| ″ | 11.84 | 32 |
| Example | 4.96 | 72 |
| ″ | 5.87 | 67 |

The Example coupons provided about 70% inhibition after 96 hours of continuous corrodent exposure, while the Control coupons provided only about 30% protection after the same exposure. The Example treatment provided more than twice the inhibition than the Control treatment after 96 hours of continuous corrodent contact.

What is claimed is:

1. A composition comprising a mixture of:
a corrosion inhibitor comprising an amine group;
a particulate comprising Al₂O₃ and having an average particle size between 1 nm and 1000 nm; and
a solvent.

2. The composition of claim 1 wherein the composition comprises 10 wt % to 80 wt % of the corrosion inhibitor.

3. The composition of claim 1 wherein the composition comprises 0.1 wt % to 2 wt % of the particulate.

4. The composition of claim 1 wherein the amine group is a primary amine group.

5. The composition of claim 1 wherein the corrosion inhibitor comprises an imidazoline, an amidoamine, a quaternary ammonium compound, an aromatic amine, an amine condensate, or a combination of two or more thereof.

6. The composition of claim 5 wherein the imidazoline comprises a compound having the structure 1: 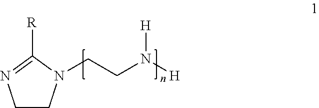
wherein R is a linear or branched alkyl, alkenyl, alkaryl, or aryl group having 12 to 30 carbons and n is an integer between 1 and 5; and/or
wherein the amidoamine comprises a compound having structure 2: 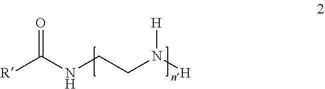
wherein R′ is a linear or branched alkyl, alkenyl, alkaryl, or aryl group having 12 to 30 carbons and n′ is an integer between 1 and 5.

7. The composition of claim 5 wherein
the quaternary ammonium compound comprises a C10-C20 alkyl dimethyl benzyl ammonium chloride, a C12-C18 alkyl dimethyl benzyl ammonium chloride, dodecyl didecyl dimethyl ammonium chloride, hexadecyltrimethylammonium chloride, benzalkonium chloride, or a combination of two or more thereof; or
wherein the aromatic amine comprises a pyrimidine, a pyridine, a quinoline, a purine, an acridine, an amino-functionalized pyrimidine, pyridine, quinoline, purine, or acridine; a carboxyl-functionalized pyrimidine, pyridine, quinoline, purine, or acridine; a conjugate base of a carboxyl-functionalized pyrimidine, pyridine, quinoline, purine, or acridine; or a combination of two or more thereof; or
wherein the amine condensate is a reaction product of ethylene diamine, diethylene triamine, triethylenetetramine, tetraethylenepentamine, N-(2-aminoethyl)-1,2-ethanediamine, or a combination of two or more thereof; with a saturated fatty acid, a monounsaturated fatty acid, a polyunsaturated fatty acid, or a combination of two or more thereof; or wherein the amine condensate is a reaction product of diethylene triamine with tall oil fatty acid.

8. The composition of claim 1 wherein the particulate consists essentially of Al₂O₃ or wherein the particulate is an Al₂O₃-coated silica particulate.

9. The composition of claim 1 wherein an average particle size of the particulate is between 5 nm and 200 nm.

10. The composition of claim 1 wherein the corrosion inhibitor and the particulate are present in the composition at a weight ratio of 1000:1 to 5:1, or wherein the corrosion inhibitor and the particulate are present in the composition at a weight ratio of about 100:1.

11. The composition of claim 1 wherein the solvent comprises xylene, benzene, toluene, aromatic naphtha, diesel, kerosene, fuel oil, or a combination of two or more thereof.

12. The composition of claim 1 further comprising an adjuvant selected from biocides, hydrogen sulfide scavengers, anti-emulsifiers, anti-foaming agents, emulsifiers, foamers, paraffin inhibitors, asphaltene inhibitors, hydrate inhibitors, or a combination of two or more thereof.
